(19) United States
(12) Patent Application Publication
(10) Pub. No.: US 2016/0300052 A1
(43) Pub. Date: Oct. 13, 2016

(54) PORTABLE ELECTRONIC DEVICE WITH SECURITY SYSTEM

(71) Applicant: John Bailey, San Diego, CA (US)

(72) Inventor: John Bailey, San Diego, CA (US)

(21) Appl. No.: 14/684,660

(22) Filed: Apr. 13, 2015

(51) Int. Cl. G06F 21/36; G06K 9/00; H04N 7/18; H04M 1/02; G06F 21/44

(52) U.S. Cl. CPC G06F 21/36; H04M 1/0264; G06F 21/44; H04N 7/185; G06K 9/00255; G06F 2221/2129

(57) ABSTRACT

A PED configured to record and monitor access attempts and a method of recording and monitoring attempts to access a PED are provided. The PED includes a display, a camera mounted to the display and an access recording program. The PED includes an access program configured to lock access to the applications. An access recording program processes the number of unsuccessful access attempts and may actuate the camera so as to take a picture of the user who attempted the unsuccessful attempts. The picture is wirelessly transmitted to the owner's email address or a phone number directed by the owner.

### TECHNICAL FIELD

Portable electronic devices (“PEDs”) configured to record and monitor access attempts is provided.

### BACKGROUND OF THE INVENTION

Portable electronic devices (“PEDs”) are commonly used. Such PEDs include a front facing camera, and are equipped to transmit and receive information through a wireless network, such as 4g. Such networks allows the PEDs to access various websites and have become useful in assisting users with obtaining their financial information and conducting financial transactions. Accordingly, PEDs may be programmed to automatically lock access to the PED until a password or code is entered.

The password/code is typically a random assembly of letters, characters, a word or words, or a pattern. The user simply tries to access the PED by either pushing a button which opens up the password/code page wherein a respective word, code or pattern is entered. FIG. 1a shows a PED wherein the password page requires a word or character entry. FIG. 1b shows a PED requiring a pattern for access. However, it is unknown if a person has attempted to access the PED. Accordingly, it remains desirable to have a PED which can track and record unsuccessful attempts at accessing the PED.

### SUMMARY OF THE INVENTION

A PED configured to record and monitor access attempts and a method of recording and monitoring attempts to access a PED are provided. The PED includes a display, a camera mounted to the display and an access recording program. The PED includes an access program configured to lock access to the applications. The access program generates an entry on the display and an input such as a keyboard or a pattern board. The user engages the input so as to provide an access code. Upon receipt of the access code, the access program provides the user with access to the PED.

The access recording program may be further configured to count the number of unsuccessful attempts made to access the PED. The access recording program processes the number of unsuccessful access attempts and after a predetermined number of unsuccessful attempts actuates the camera so as to take a picture of the user who attempted the unsuccessful attempts.

The access recording program may be further configured to store the picture and automatically send the picture to the owner of the PED. The access recording device may be further configured to send information as to the location and time the unsuccessful attempts at accessing the PED was made. Accordingly, the owner of the PED may learn who has tried to access their PED, and where and when an unauthorized attempt at accessing their phone was made.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be better understood when read in conjunction with the following drawings where like structure is indicated with like reference numerals and in which:

FIG. 1a is an illustrative view showing, a password entry on the display of a PED;

FIG. 1b is an illustrative view showing a pattern entry on the display of a PED;

FIG. 2 is a perspective view of a PED having an access recording program;

FIG. 3 is a system diagram showing the components of the PED; and

FIG. 4 is a chart showing the steps of a method for recording and monitoring attempts to access a PED.

### DETAILED DESCRIPTION OF THE PREFERRED EMBODIMENTS

A PED configured to record and monitor access attempts and a method of recording and monitoring attempts to access a PED are provided. For use herein, a PED is a portable device having wireless communication with a remote server, such as a phone like an iPhone® or Sony Galaxy®, a tablet such as iPad® or Fire HD®, or a laptop computer such as a surface pro®. The PED is configured to take a picture of the person attempting an unauthorized/unsuccessful attempt to access the PED.

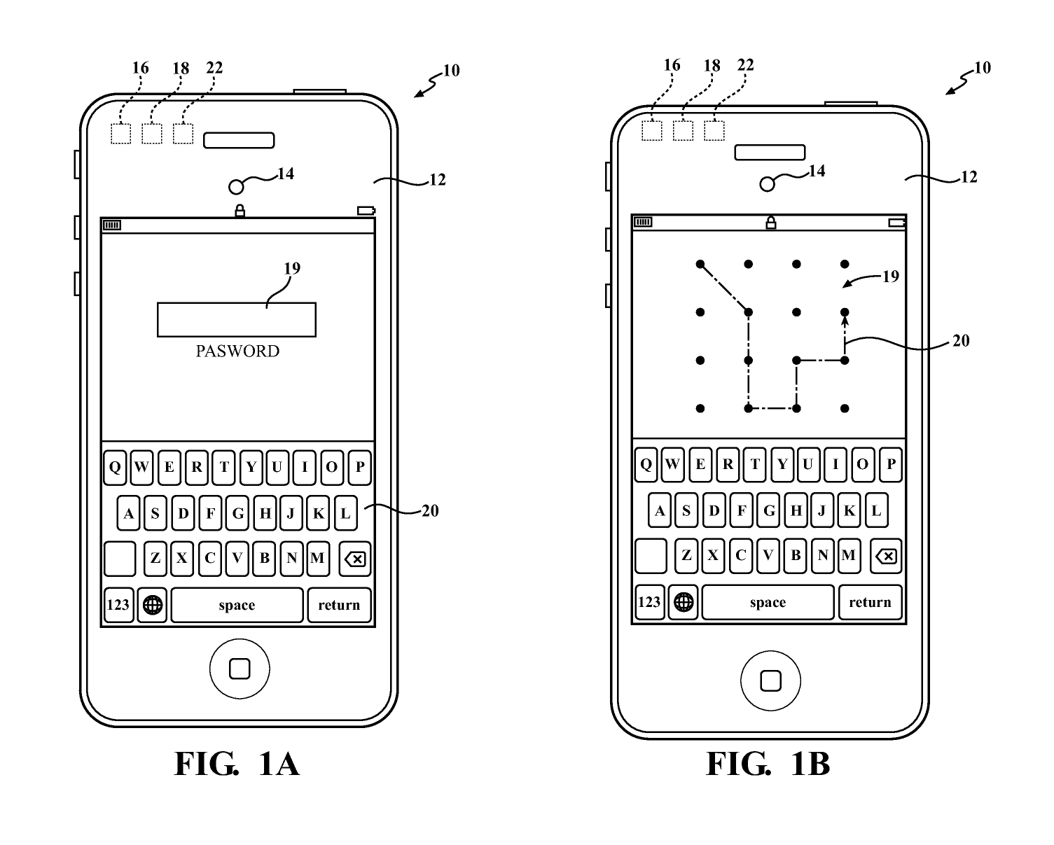

With reference now to FIG. 1a, an illustrative embodiment of the PED 10 is provided. The PED 10 includes a display 12, a camera 14 mounted to the display 12, an access program 16 and an access recording program 18. The camera 14 is preferable mounted to the front of the PED 10. The access program 16 configured to lock access to the applications. The access program 16 generates an entry 19 on the display 12 and an input 20 such as a keyboard. The user engages the input 20 so as to provide an access code. FIG. 1b, is an illustrative example of an entry 19 being pattern board, and the input 20 is a pattern drawn on the pattern board wherein the user must provide a predetermined pattern in order to access the FED 10, as indicated by the dashed lines.

Upon receipt of the access code, the access program 16 provides the user with access to the PED 10. The access program 16 is further configured to report to the access recording program 18 the number of unsuccessful attempts made to access the PED 10. The access recording program 18 processes the number of unsuccessful access attempts and may actuate the camera 14 so as to take a picture of the user who attempted the unsuccessful attempts.

The access recording program 18 may be further configured to store the picture and automatically send the picture to the owner of the PED 10. The access recording device may be further configured to send information as to the location and time the unsuccessful attempts at accessing the PED 10 was made. Accordingly, the owner of the PED 10 may learn who has tried to access their PED 10, and where and when an unauthorized attempt at accessing their phone was made. The PED 10 may also include a facial recognition segment 22 configured to scan the images and contacts stored in the PED 10 and match the captured image with a person in the database of the PED 10. Thus, the name of the person as well as the image may be transmitted to the owner.

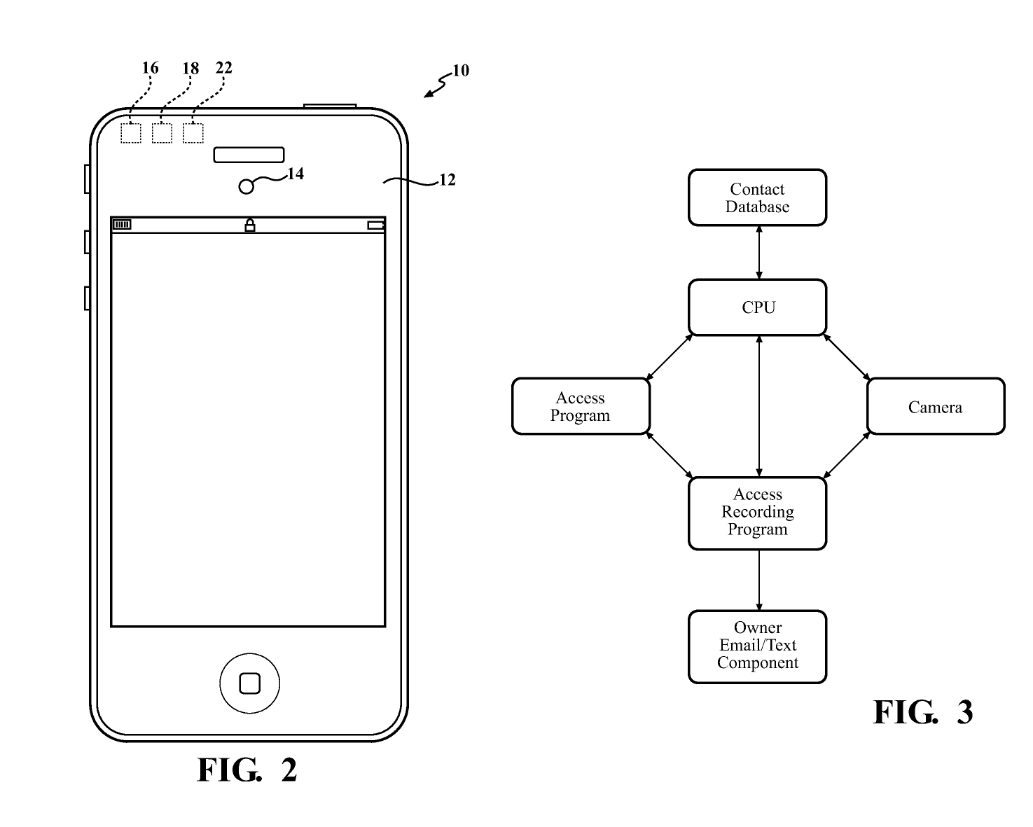

With reference now to FIG. 2, a PED 10 with an access recording program 18 is provided. The PED 10 includes a display 12. The display 12 may be a touch screen configured to show images responsive to a touch. Such displays are currently known and used and may be seen in a PED 10 commonly referenced as an iPhone. The images include icons for accessing various websites such as a financial corporation. The PED 10 is includes various software executable programs such as a clock, and a contact database. The contact database may include a picture of each of the people in the contact database. The PED 10 may be further configured to receive the owner's information, to include a primary email address.

The PED 10 includes a camera 14 mounted to the display 12. The camera 14 is configured to take a picture of the face of the user. Any such camera 14 currently known and used in the art may be adapted for use herein, illustratively including but not limited to the front facing camera 14 found on the iPhone®, iPad®, Fire HD® tablet, Sony Galaxy® phone or surface pro® tablet.

The PED 10 includes an access program 16. The access program 16 is configured to restrict access to the PED 10. The access program 16 may restrict access to the PED 10 after the PED 10 has remained idle after a predetermined period of time, has gone into sleep mode, or upon being turned on The access program 16 may require either a code to gain access to the PED 10. It should be appreciated by those skilled in the art that the term “gain access” means the ability of a user to navigate through the various software programs embedded in the PED 10. The code may not necessarily be a word, but an alphanumeric entry, a numeric entry, or a pattern. The access program 16 may allow for any code entry desired by the owner of the PED 10.

The access program 16 generates an access entry box, or pattern board as the user dictates. In the instance that an entry box is generated and a touchscreen display 12 is provided, a keyboard may appear allowing the user to enter the code. It should be appreciated that some PED 10s have a physical keyboard allowing the user to type in the code. In the instance that a pattern board is generated, the user simply draws the pattern to generate the code.

With reference again to FIG. 2 and now to FIG. 3, the access recording program 18 is configured to count the number of unsuccessful attempts made to access the phone. The access recording program 18 actuates the camera 14 so as to take a picture of the user who attempted the unsuccessful attempts. The access recording program 18 may be further configured to store the picture and automatically send the picture to the owner of the PED 10.

In one embodiment, the access recording program 18 is configured to process the PED 10 so as to determine the primary email address of the owner. In another embodiment the access recording program 18 may be configured to receive an email address for which to send the picture to. The access recording program 18 may be configured to transmit the picture to multiple email addresses entered by the owner. The access recording device may be further configured to send. The access recording device may process the PED 10, in particular a GPS program, or the clock program so as to provide information as to the location and time the unsuccessful attempts at accessing the PED 10 was made. Accordingly, the owner of the PED 10 may learn who has tried to access their PED 10, and where and when an unauthorized attempt at accessing their phone was made. The access recording program 18 may be installed in the PED 10 before sales and distribution or may be downloaded by the owner of the phone.

With reference now to FIG. 3, an operation of the PED 10 is provided. The access program 16 locks the PED 10. Wherein, the entry 19 is provided on the display 12 when the PED is activated from a sleeping state/locked state. Such an activation may occur by pressing a button or swiping on the display 12 in instances where the display is a touch screen. Upon the first attempt at entering the access code, the access program initiates the access recording program 18. The access recording program 18 monitors the number of attempts made to enter the access code. After a predetermined number of failed responses, the access recording program 18 initiates the camera 14 which takes a picture of the user.

The access recording program then transmits the picture to the owner of the PED by demanding that the PED send the picture to the predetermined phone number vis-à-vis a text or to an email. The access recording program may be further configured to transmit the picture to the CPU which may actuate the facial recognition segment 22. The facial recognition segment 22 then process the contact database 24 of the phone and attempts to match the picture with a person on the contact database. In the event of a match, the access recording program 18 then transmits the name of the person and the picture to the predetermined phone number or to a predetermined email, or both.

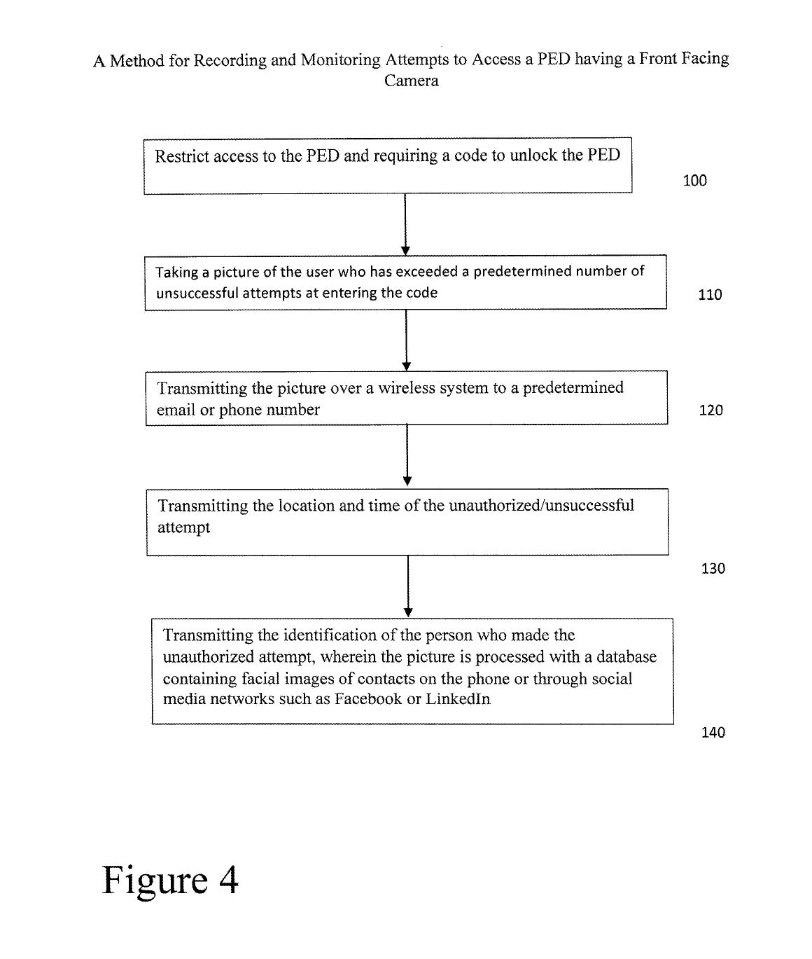

A method for recording and monitoring attempts to access a PED 10 is also provided. With reference now to FIG. 4 the steps of the method are provided. The method is implemented on a PED 10 having a camera 14 configured to take a picture of the person using the PED 10. The method includes the step 100 of restricting access to the PED 10 and requiring a code to unlock the PED 10. The method includes the step 110 of taking a picture of the user who has exceeded a predetermined number of unsuccessful attempts at entering the code. The method may further include the step 120 of transmitting the picture over a wireless system to a predetermined email or phone number. The method may further include the step 130 of transmitting the location and time of the unauthorized/unsuccessful attempt. The method may further include the step 140 of transmitting the identification of the person who made the unauthorized attempt, wherein the picture is processed with a database containing facial images of contacts on the phone or through social media networks such as Facebook or LinkedIn.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination.

We claim:

1. A portable electronic device configured to record unauthorized attempts to access said portable electronic device, the portable electronic device comprising:
a display;
a camera mounted to the display;
and an access program configured to lock access to the applications, the access program generates an entry box on the display configured to receive an access code; and
an access recording program, the access recording program processing the number of unsuccessful access attempts and actuates the camera so as to take a picture of a user who attempted a predetermined number of unsuccessful attempts at accessing the portable electronic device.

2. The portable electronic device as set forth in claim 1, wherein the access code is an alphanumeric combination.

3. The portable electronic device as set forth in claim 1, wherein the camera is mounted on the display.

4. The portable electronic device as set forth in claim 1, wherein the camera is mounted on the front of the portable electronic device.

5. The portable electronic device as set forth in claim 1, wherein the access recording program may be further configured to store the picture and automatically send the picture to the owner of the portable electronic device.

6. The portable electronic device as set forth in claim 5, wherein access recording device may be further configured to send information as to the location and time the unsuccessful attempts at accessing the portable electronic device was made.

7. The portable electronic device as set forth in claim 6, wherein the portable electronic device includes a facial recognition program configured to match the picture with any one contact image stored in the portable electronic device so as to provide the owner with a name of the person in said picture.

8. A method for recording and monitoring attempts to access a portable electronic device, the method implemented on a portable electronic device having a camera configured to take a picture of the person using the portable electronic device, the method comprising the steps of:
restricting access to the portable electronic device and requiring a code to unlock the portable electronic device;
taking a picture of the user who has exceeded a predetermined number of unsuccessful attempts at entering the code; and
transmitting the picture over a wireless system to a predetermined email or phone number.

9. The method as set forth in claim 8 further include the step of transmitting the location and time of the unauthorized/unsuccessful attempt.
